(19) United States
(12) Patent Application Publication
(10) Pub. No.: US 2014/0281741 A1
(43) Pub. Date: Sep. 18, 2014

(54) METHOD, USER INTERFACE AND APPARATUS FOR CLOUD SERVICE CONFIDENCE LEVEL GENERATION AND DISPLAY

(71) Applicant: KHUSHBOO SHAH BOHACEK, PHILADELPHIA, PA (US)

(72) Inventor: KHUSHBOO SHAH BOHACEK, PHILADELPHIA, PA (US)

(21) Appl. No.: 13/832,092

(22) Filed: Mar. 15, 2013

(51) Int. Cl. G06F 11/34

(52) U.S. Cl. CPC G06F 11/3409
USPC 714/47.3

(57) ABSTRACT

A method, user interface and system are provided that enable a user to monitor an information technology (“IT”) service that is provided via an electronics communications network. A user is visually presented with values that indicate a probability of IT service degradation or failure. A unified monitor automatically employs a set of parametric sensors to develop a comprehensive view of users cloud service providers and assess the robustness and security of specified services. The monitor combines relevant information that may affect a user's confidence in services and applies algorithms to assess and forecast service reliability at any given time by vendor and dedicated computational assets. The monitor may present service predictions and reliability assessments through a visual dashboard along with available or recommended mitigation actions. The dashboard enables simultaneous visualization of assets, service, and metrics and thereby supports timely intuitive forensic analysis and optionally prompt application of mitigation activities.

### FIELD OF THE INVENTION

The present invention relates to distributed electronic information technology. More particularly, the present invention relates to managing information technology processes by means of networked and remotely located computational assets.

### BACKGROUND OF THE INVENTION

Commercial, public and private entities are increasingly relying upon vendor services deliver via the Internet to perform and support mission critical data processing and information technology services. Such services are generally referred to as Cloud-based services.

Failure or degradation of these Cloud-based services, even temporarily or partially, can severely damage the operations of, and possibly incur additional expense to, an entity engaging the service. Sophisticated entities know that performance parameters of individuated Cloud-based services can be dynamically accessed to continuously appraise the current reliability of these services. Entities with sufficient technical resources and expertise will thus consistently monitor one or more of these leading reliability indicators of specific Cloud-based service providers. Such constant evaluation is particularly helpful when low cost mitigation strategies may be timely employed to reduce operation risk and/or the potential damage of exposure to such risk. In addition, evaluations of the historical performance of individual Cloud service providers may be considered by system administrators in evaluating the probability of service degradation or failure in the context of the current values of monitored service parameters.

The prior art fails to optimally evaluate the history of cloud asset or cloud service performance to determine an appropriate current confidence in the examined assets or services and predict the likelihood of future failures, problems or issues of cloud resource system management.

The prior art, however, additionally fails to optimally provide or employ Cloud-service users with a method, user interface or system to best enable a subscriber to a Cloud-based information technology service to monitor service performance, determine cloud asset or cloud system performance, generate a service reliability indicator, and encourage access to risk and damage mitigation alternatives.

### OBJECTS AND SUMMARY OF THE INVENTION

Toward this and other objects that are made obvious in light of the disclosure, a method, user interface and system are provided to enable a human administrator (hereinafter, “system administrator”) to monitor a data processing service that is provided via an electronics communications network. In a first optional aspect of the invented method, user interface and system (hereinafter, “the present invention”), the system administrator is visually presented with parametric values that indicate a probability of service degradation or failure. According to a second optional aspect of the present invention, calculations of one or more parametric values are automatically generated and may be at least partially derived from (a.) measurements of current performance factors of a target system, (b.) contextual factors of network performance; and/or (c.) historical valuations of vendor-specific performance.

According to a first embodiment of the present invention, a unified monitor automatically employs a set of parametric sensors to develop a comprehensive view of users cloud service providers and to assess the robustness and security of specified services and associated computational assets. The unified monitor combines relevant information that may affect a user's confidence in Cloud services and applies algorithms to assess and forecast service reliability, forecast confidence levels, and estimate business impact or failure of service at any given time by a cloud service vendor and dedicated computational assets. Optionally, alternatively or additionally, the unified monitor may present service reliability information, business impact forecasts, predictions and assessments through a visual dashboard along with available or recommended mitigation actions. The unified monitor enables timely Cloud-based service forensics, business impacts of service failures, and service reliability estimation via human intuitive determination rather than by an exhaustive and continuous interrogation of dynamically varying performance parameters by the system administrator.

In additional optional aspects of the invented method, a rendered dashboard visually represents (a.) high-level confidence metrics as established by the service recipient or system administrator; and/or (b.) measurements and information related to identified asset qualities, such as by assigned web server, database, vendor, or type of tasked service. One or more high-level metrics may optionally be further divided into lower level or constituent sub-metric indicator values. User selection of one or more indicator value windows may cause the dashboard to render additional information about a related sub-metric. Information accessible via the dashboard and related to one or more sub-metric indicators may be further divided into event class, wherein one or more event class may be associated with a corresponding raw event or series or history of events. The dashboard enables simultaneous visualization of assets, service, and metrics and thereby supports timely intuitive forensic analysis and optionally prompt application of mitigation activities.

### BRIEF DESCRIPTION OF THE FIGURES

These, and further features of the invention, may be better understood with reference to the accompanying specification and drawings depicting the preferred embodiment, in which:

FIG. 1 illustrates an electronic communications network comprising a system administrator system, a plurality of service vendor portal systems, a plurality of assignable servers and a plurality of additional IT assets;

FIG. 2 is a schematic of a system administrator system of FIG. 1;

FIG. 3 is a flow chart of a top level of the invented method, wherein the system administrator of FIG. 1 tasks one or more cloud service systems of the network of FIG. 1 with cloud service operations and evaluates the reliability of each tasked cloud service system;

FIG. 4 is a flow chart of a top level of the invented method and showing additional optional aspects of the invented method, wherein the system administrator of FIG. 1 tasks one or more cloud service systems of the network of FIG. 1 with cloud service operations and evaluates the reliability of each tasked cloud service system;

FIGS. 5A and 5B present a plurality of detailed flowcharts of aspects of the system software and the analytics engine of the system administrator system of FIG. 1;

FIG. 6 is an illustration of the dashboard image as rendered on a video display of the sys admin of the system administrator system of FIGS. 1 and 2;

FIG. 7 is a representation of the derivation of a confidence value of a selected cloud service;

FIG. 8 is a representation of the derivation of an organization confidence value;

FIG. 9 is a representation of the derivation of a metric confidence value of a selected metric of a cloud service;

FIG. 10 is a flowchart of a process in accordance with the invented method that may be executed by the system administration system of FIGS. 1 and 2;

FIG. 11 is a flowchart of a process of optional aspects of the invented method that may be executed by the system administration system of FIGS. 1 and 2;

FIG. 12 is a schematic of a sensor message that is transmitted from a cloud system sensor of FIG. 1 to the system administration system of FIGS. 1 and 2;

FIG. 13 is a schematic of an algorithm record that may be accessed by the system administration system of FIGS. 1 and 2 to generate confidence values;

FIG. 14 is a schematic of a mitigation record that may be accessed by the system administration system of FIGS. 1 and 2 to generate confidence values;

FIG. 15 is a schematic diagram of a portion of the Internet that includes an alternate invented server;

FIG. 16 is a flow chart of the operation of the alternate cloud server of FIG. 15 in generating and rendering an asset confidence value; and

FIG. 17 is a representation of a first cloud asset data record that is maintained in the alternate cloud server of FIG. 15 and acts as a record of the first asset confidence value formula and associated values, coefficients and history of the first asset.

### DESCRIPTION

It is to be understood that this invention is not limited to particular aspects of the present invention described, as such may, of course, vary. It is also to be understood that the terminology used herein is for the purpose of describing particular aspects only, and is not intended to be limiting, since the scope of the present invention will be limited only by the appended claims.

Methods recited herein may be carried out in any order of the recited events which is logically possible, as well as the recited order of events.

Where a range of values is provided herein, it is understood that each intervening value, to the tenth of the unit of the lower limit unless the context clearly dictates otherwise, between the upper and lower limit of that range and any other stated or intervening value in that stated range, is encompassed within the invention. The upper and lower limits of these smaller ranges may independently be included in the smaller ranges and are also encompassed within the invention, subject to any specifically excluded limit in the stated range. Where the stated range includes one or both of the limits ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, the methods and materials are now described.

It must be noted that as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements, or use of a “negative” limitation.

Referring now generally to the Figures and particularly to FIG. 1, FIG. 1 illustrates an electronic communications network 2 comprising a system administrator system 4, a plurality of service vendor portal systems 6, a plurality of assignable servers 8 and a plurality of additional IT assets 10. The electronic communications network 2 (hereinafter, “network” 2) may comprise the Internet 12 and a telephony network 14.

The plurality of service vendor portal systems 6, the plurality of assignable servers 8 and the plurality of additional IT assets 10 are each separately addressable cloud service providers and each may include one or more monitoring sensor software S.1-S.N (hereinafter, “sensors” S.1-S.N). Each sensor S.1-S.N monitors a quantifiable quality of a hosting system 6, 8 10 & 12 that relates to a performance aspect of the hosting system 6, 8 10 & 12. One or more system 4, 6, 8, 10 & 12 may be (a.) a network-communications enabled THINKSTATION WORKSTATION™ notebook computer marketed by Lenovo, Inc. of Morrisville, N.C.; (b.) a NIVEUS 5200 computer workstation marketed by Penguin Computing of Fremont, Calif. and running a LINUX™ operating system or a UNIX™ operating system; (c.) a network-communications enabled personal computer configured for running WINDOWS XP™, VISTA™ or WINDOWS 7™ operating system marketed by Microsoft Corporation of Redmond, Wash.; (d.) a MACBOOK PRO™ personal computer as marketed by Apple, Inc. of Cupertino, Calif.; (e.) an IPAD™ tablet computer as marketed by Apple, Inc. of Cupertino, Calif.; (f.) an IPHONE™ cellular telephone as marketed by Apple, Inc. of Cupertino, Calif.; (g.) an HTC TITAN II™ cellular telephone as marketed by AT&T, Inc. of Dallas, Tex. and running a WINDOWS 7™ operating system as marketed by Microsoft Corporation of Redmond, Wash.; (h.) a GALAXY NEXUS™ smart phone as marketed by Samsung Group of Seoul, Republic of Korea or and running an ANDROID™; (i.) a TOUGHPAD™ tablet computer as marketed by Panasonic Corporation of Kadoma, Osaka, Japan and running an ANDROID™ operating system as marketed by Google, Inc. of Mountain View, Calif.; or (j.) other suitable computational system or electronic communications device known in the art capable of providing or enabling a financial web service known in the art.

Referring now generally to the Figures and particularly to FIG. 2, FIG. 2 is a schematic of the system administrator system 4 (hereinafter, “sys admin” 4). The sys admin 4 includes a central processing unit 4B, or “CPU” 4A. An internal communications bus 4B bi-directionally communicatively couples the CPU 4A with other circuits of the sys admin 4A, to include a video output display module 4C, a user data input module 4D, a wireless interface circuit 4E and a system memory 4F. The wireless interface circuit bi-directionally communicatively couples the CPU 4A with network 2.

The system memory 4F stores various software, to include an operating system SW.2, a system software SW.3 and an analytics engine SW.4. The system software SW.3 and the analytics engine SW.4 in combination enable the sys admin 4 to execute or instantiate the steps of the method of the present invention (hereinafter, “the invented method”).

Referring now generally to the Figures and particularly to FIG. 3, FIG. 3 is a flow chart of a top level of the invented method, wherein the sys admin 4 tasks one or more systems 6, 8 &10 of the network 2 with cloud service operations CS.1-CS.3 in step 3.00. The cloud services CS.1-CS.3 provided by the one or more systems 6, 8 & 10 may include information technology infrastructure provided as a service, i.e., “IaaS” CS.1, information technology platform capacity provided as a service, i.e., “PaaS” CS.2, and/or software provided as a service, i.e., “SaaS” CS.3. In step 3.02 the sys admin 4 receives sensor messages SM.1-SM.N from sensors S.1-S.N positioned remotely from the sys admin 4 and within cloud service systems 6, 8 & 10. The sys admin 4 applies the analytics engine SW.3 in step 3.04 and generates confidence values CV.1-CV.N, wherein each confidence value CV.1-CV.N is a quantitative value that is derived at least partially from sensor data extracted from the sensor messages SM.1-SM.N. One or more confidence values CV.1-CV.N are rendered by the sys admin 4 within the dashboard image 16 as rendered by the display module 4C.

Referring now generally to the Figures and particularly to FIG. 4, FIG. 4 is a flow chart of a top level of the invented method and showing additional optional aspects of the invented method, wherein the sys admin 4 tasks one or more systems 6, 8 & 10 of the network 2 with cloud service operations CS.1-CS.3 in step 4.00. The sys admin 4 receives sensor messages SM.1-SM.4 in step 4.02, wherein the sensor messages SM.1-SM.4 received by the sys admin 4 include variously include quantitative measures including a technology system health parametric value, of a first sensor message SM.1; an information security parametric value of a second sensor message SM.2; a governance, risk, and compliance parametric value of a third sensor message SM.3; and a social parametric value of a fourth sensor message SM.4. The social parametric value of the fourth sensor message may be derived from a plurality of sources of opinion concerning the reliability of an identified cloud service system 6, 8 & 10. The sys admin 4 applies the analytics engine SW.3 in step 4.04 and generates the confidence values CV.1-CV.N. One or more confidence values CV.1-CV.N are then rendered by the sys admin 4 within the dashboard image 16 as rendered by the display module 4C.

Referring now to FIG. 5A and FIG. 5B, FIG. 5A and FIG. 5B presents a plurality of detailed flowcharts of aspects of the system software SW.2 and the analytics engine SW.3.

Confidence Monitoring Module takes information from various sensors such as Health, GRC, Security and Social. The data that is collected by the sensors is further analyzed by the Event Analysis Engine (EAE). Event Analyzer in the EAE normalizes the event and applies pre-processing rules to decide if the arriving event can have an impact on the overall confidence of the Cloud service. If the arriving event can have potential impact, the event is passed on to the Impact Analyzer (IA). IA assigns the impact of service degradation if any to the normalized event. If the assigned impact is higher than a pre-defined threshold this event becomes a Confidence Alert (CA) or otherwise the event gets discarded.

Confidence Analytics Engine takes the CA and applies the rules to decide which algorithm to apply on that alert. Based on the algorithm, Confidence Level (CL) is estimated for a node, for each asset, for every service provider as well as across providers and assets.

Decision Engine looks at the CL and decides if the CA changed the current CL. If the CL changes to higher than PAST-CL, then a new confidence incident is created. If the CL is lower than the PAST-CL, the CA is counted as a part of the same incident.

Each of the confidence incident is classified and mitigation action is assigned based on the class of the incident in Confidence Mitigation Engine. This information is displayed on the Cloudamize dashboard.

Referring now to FIG. 6, FIG. 6 is an illustration of the dashboard image 16 as rendered on a video display 4G of the sys admin 4. The dashboard image 16 is a user interface that enables a user to view a plurality of cloud service confidence indicators, the user may sequentially select one of a plurality of cloud services 602-610, wherein a plurality of confidence parameters 612-618 may be displayed. Each confidence parameter may be associated with a contemporaneous indicator 612A-618C of a sub-metric confidence value. The user may, for example email the cloud service 602 by means of the input module 4D, in which case the numerical confidence values 612-618 related to the email cloud service are indicated within the dashboard image 16. In addition, the plurality of sub-metric confidence level indicators 612A-618C from which the numerical confidence values 612-618 are at least partially derived. In addition, a history image 620 displays historical data related to the selected cloud service, e.g., the mail function 602.

Referring now to the Figures and particularly FIGS. 7, 8 and 9, FIG. 7 is a representation of the derivation of a confidence value of a selected cloud service, e.g., electronic mail 7.02, a web server 7.04, a data storage service 7.06, a customer service management service 7.08 and a computational capacity 7.10. The user may select each sensor value of a sensor S.1-S.N that is associated with a selected cloud service and direct the system software SW.2 and the analytics software SW.3 to derive therefrom a confidence value CV of the selected cloud service 7.02-7.10.

Referring now to the Figures and particularly FIGS. 7, 8 and 9, FIG. 7 is a representation of the derivation of a confidence value of an organization, such as Amazon of Seattle, Wash. and GOOGLE APPS™ cloud service as provided by Google, Inc. of Mountain View, Calif. The user may select each sensor value of a sensor S.1-S.N that is associated with a selected organization, e.g., Amazon or Google and direct the system software SW.2 and the analytics software SW.3 to derive therefrom a confidence value CV for the selected organization.

FIG. 9 is a representation of the derivation of a metric confidence value 900 of a selected metric of a cloud service, e.g., health 9.02, data security 9.04, governance, risk management and compliance 9.06 and social indicators 9.08. FIG. 9 further represents the sub-metrics 9.10-9.16 from which the selected metric 9.02-9.08 is at least partly derived. The user may select each sensor value of a sensor S.1-S.N that is associated with a selected metric 9.02-9.10 and direct the system software SW.2 and the analytics software SW.3 to derive therefrom a metric confidence value 9.00 CV of the selected cloud metric 9.02-9.10.

Referring now to the Figures and particularly FIG. 10, FIG. 10 is a software flowchart that discloses aspects of the invented method that may be applied to generate Confidence Values 700, 800 & 900. The process of FIG. 10 may be executed by the sys admin 4 and relies upon Sensor Messages SM.1-SM.N of FIG. 12 and Algorithm Records AR.1-AR.N of FIG. 13.

The sys admin determines in step 10.02 whether the user has input a new admin value VALUE.1-VALUE.N for storage in an algorithm record AR.1-AR.N, and if so, updates the selected algorithm record AR.1-AR.N with the newly input admin value VALUE.1-VALUE.N in step 10.04.

The sys admin 4 determines in step 10.06 if the sys admin 4 has received a sensor message SM.1-SM.N since the last execution of step 10.02. If no new sensor message SM.1-SM.N is determined to have been received in step 10.06, the sys admin proceeds on to step 10.08. The sys admin 4 determines in step 10.08 whether to (a.) cease the execution of the logic loop of step 10.02 through step 10.20 and to perform alternative computational operations of step 10.10, or (b.) to proceed on to an additional execution of step 10.02.

When the sys admin 4 determines in step 10.06 to have received a sensor message SM.1-SM.N since the last execution of step 10.02, the sys admin 4 proceeds on to step 10.12 and selects the algorithm record AR.1-AR.N associated with the sensor S.1-S.N from which the received sensor message SM.1-SM.N was issued. The sys admin 4 proceeds to step 10.14 to apply the algorithm ALGO of the algorithm record selected in step 10.12 to generate a confidence value CV of the referenced asset 6, 8 & 10.

The sys admin 4 determines in step 10.16 whether the confidence value CV calculated in step 10.14 exceeds a confidence level alert level value CVAL. When the sys admin determines in step 10.16 that the confidence value CV calculated in step 10.14 does not exceed confidence level alert level value CVAL, the sys admin 4 issues an alert message and renders the alert message in step 10.18 by means of the display module 4C.

The sys admin 4 proceeds from either step 10.16 or step 10.18 to record the confidence value CV calculated in step 10.14 in the system memory 4F, and updates a rendering of the dashboard image by the display module 4C of the confidence values 600, 700, 800 & 900.

Referring now generally to the Figures and particularly to FIG. 11, FIG. 11 is a software flowchart of optional and additional mitigation actions, both automatic and as directed by a human system administrator that may be affected by means of the sys admin 4. The process of FIG. 11 relies upon a mitigation record MR.1-MR.N of FIG. 14. In step 11.00 the sys admin 4 initiates automatic mitigation actions as stored in a mitigation record MR.1-MR.N that references a cloud service system 6, 8 & 10 identified as the source address ADDR.SRC of the sensor message SM.1-SM detected in step 10.06 as received by the sys admin 4. The sys admin 4 further both issues a mitigation advisory message and renders the mitigation advisory message by means of the display module 4C in step 11.02, wherein the mitigation advisory message includes advisory information stored in the mitigation record MR.1-MR.N accessed in step 11.00. The sys admin 4 proceeds from step 11.06 or step 11.04 to step 10.20. Referring now generally to the Figures and particularly FIG. 12, FIG. 12 is a schematic of an exemplary first sensor message SM.1 that is transmitted from a cloud system sensor S.1-S.N of FIG. 1 to the sys admin 4. Each sensor message SM.1-SM.N includes a sensor message identifier S.MSG.ID; a source address ADDR.SRC of the sensor S.1-S.N that issued the instant sensor message S.1-S.N; a destination address ADDR.DES of the sys admin 4; an identifier S1.1D of the issuing sensor S.1-S.N; and a sensor value VALUE.S1 generated by the sensor S.1-S.N identified by the identifier S1.1D of the comprising sensor message S.1-S.N.

Referring now generally to the Figures and particularly to FIG. 13, FIG. 13 is a schematic of an exemplary first algorithm record AR.1 that may be accessed by the sys admin 4 to generate confidence values CV 600, 700, 800 & 900. Each algorithm record includes an algorithm record identifier A.REC.ID; an asset identifier ASSET.ID that identifies the system 6, 8 & 10, organization 802-810 or metric 902-908 for which the comprising algorithm record AR.1-AR.N is applied to generate a confidence value CV 600, 700, 800 or 900; an optional organization identifier ORG.ID of an organization 800-810 that is associated with the asset identified by the asset identifier ASSET.ID; an algorithm ALGO applicable to generate a confidence value CV 600, 700, 800 or 900; optionally one or more admin values VALUE.A1-VALUE.AN that are each inputted as values based upon evaluations of asset reliability, such as audits or human expert evaluations; optionally one or more sensor identifiers ID.S1-ID.SN from which sensor values VALUES.S1-VALUES.SN are received, and a history of confidence value levels CL.1 previously calculated using the algorithm ALGO of the same algorithm record AR.1-AR.N.

Referring now generally to the Figures and particularly to FIG. 14, FIG. 14 is a schematic of an exemplary first mitigation record MR.1 that may be accessed by the sys admin 4 to generate confidence values. Each mitigation record M.REC.1-M.REC.N includes a mitigation record identifier M.REC.ID, an asset identifier ASSET.ID, an optional organization identifier ORG.ID, an asset record identifier A.REC.ID of an asset record associated with a cloud service asset 6, 8 & 10, a confidence level value trigger CLVT.1 that is applied in step to determine if mitigation shall be applied by the sys admin 4, one or more automatic mitigation instructions MITI.AUTOMATIC that are implemented when the confidence level trigger level is passed; advisory information MITI.ADVISORY to be rendered by the sys admin 4 that describe elective mitigation actions, and historical mitigation data M.HISTORY.

Referring now generally to the Figures and particularly to FIGS. 15 through 17, FIGS. 15 through 17 disclose additional and optional aspects of the method of the present invention that may each be applied independently of, or in combination with, one or more other aspects of the method of the present invention as disclosed in the present disclosure.

FIG. 15 is a schematic diagram of a portion of the Internet that includes an alternate invented server 1500 (hereinafter, “cloud server” 1500), and a plurality of web service cloud asset nodes 1502-1512 (hereinafter, “cloud assets”). It is indicated by FIG. 15 that three cloud assets 1502-1506 are operated by a first cloud services provider 1514, and that three other cloud assets 1508-1512 are operated by a second cloud services provider 1516. It is further noted that four cloud assets 1502, 1504, 1508 & 1510 are indicated to provide web hosting services; that a third cloud asset 1506 provides data base services; and that a sixth cloud asset 1512 provides computation services

Sensors 1518-1528 are separately and individually positioned to monitor individual cloud assets 1502-1512. One or more sensors 1518-1528 monitor one or more cloud assets 1502-1512 for performance, availability, resource usage cost, security, compliance, social and/or one or more additional aspects of performance or values of reliability. This monitoring preferably occurs in real-time. One or more sensors 1518-1528 generate a set of confidence measurements and transmits confidence measurements CM to the cloud server 1500 wherein the analytics engine 1500B resides. The confidence measurements CM are then normalized and then processed by the cloud server 1500 to determine whether a rendered confidence value shah be updated.

The cloud server 1500 itself and/or one or more sensors 1518-1528 may monitor one or more current service confidence aspects, such as, but not limited to, (a.) aspects of computational performance of one or more cloud assets 1502-1512, such as CPU Utilization, disk reads, disk writes, memory usage, system down events, network bytes in, and network bytes out; (b.) data security qualities of one or more cloud assets 1502-1512, such as instances of system unavailability, SQL injection attack detection, XSS scripting attack detections, instances of unauthorized login attempts, the integrity checksum change detections, instances of ports being open to public Internet Protocol addresses, security policy compliance; (c.) cost related measurements, e.g., per hour billings, daily billings, and monthly billings; and/or (d.) social values, such as detected levels of credibility, reputation, reports of unexpected high costs, and dissatisfied user indications.

External confidence measurements ECM are additionally calculated by external sensors 1530-1540 that separately and individually positioned to monitor the Internet for data that relates to the performance of one or more cloud assets 1502-1512 or cloud service providers.

Each sensor 1518-1528 communicates raw and or calculated performance measurements PV to an event 1500A collector of the cloud server 1500. The event collector 1500A than provides the received performance measurements to the cloud server analytics engine 1500B. The analytics engine than calculates separate confidence measurements CM for one or more cloud servers 1502-1512 and optionally for one or more service providers 1514 & 1516. The analytics engine 1500B optionally stores performance measurements PV and confidence measurements CM as historical data for inclusion in future calculations of confidence measurements.

After calculating the confidence measurements, the analytics engine 15008 updates the confidence measurements maintained by the dashboard module 1500C, and the dashboard module then updates the visual display values of the confidence measurements CM of rendered confidence values CV.

According to still alternate preferred embodiments of the method of the present invention, raw events are reported by the sensors 1502-1512 and collected by the event collector 1500A. The event collector 1502A processes the received raw event reports and determines if the raw event (a.) is relevant and shall be reported to the analytics engine 1500B; or (b.) is not relevant and shall be discarded.

When a raw event report is forwarded from the event collector 1500A to the analytics engine 15008, alert rules are applied to determine if the raw event report shall trigger a confidence alert by the cloud server 1500.

Example of alert rules and prescribed alerts include the following:
CPU Utilization<20%=>Confidence level=green;
CPU Utilization>=20% & CPU Utilization<40%=>Confidence level=blue;
CPU Utilization>=40% & CPU Utilization<60%=>Confidence level=yellow;
CPU Utilization>=60% & CPU Utilization<80%=>Confidence level=orange; and
CPU Utilization>=80%=>Confidence level=red.

Referring now generally to the Figures and particularly to FIG. 16, FIG. 16 is a flow chart of the operation of the cloud server 1500 in generating and rendering a confidence value CV. In step 1602 the cloud server 1500 receives confidence measurements CM and external confidence measurements ECM.

In step 1604, the analytics engine 1500B selects a cloud asset 1502-1512 for calculation of a confidence value CV. For the remainder of the discussion of FIG. 16 an exemplary calculation of a confidence value CV for the first cloud asset 1502 will be offered for the sake of clarity, and is not meant to be limiting. It is understood that the aspects of the method of the present invention as applied to the first cloud asset 1502 by the method of FIG. 16 may also be applicable in whole or in part to other cloud assets 1504-1512 and cloud service providers 1514-1516.

In step 1606 the analytics engine 1500B reads the most recently received confidence measurements CM and external confidence measurements ECM related to the first cloud asset 1502 and any cloud service provider, e.g., the first cloud service provider 1514, associated with the first cloud asset 1502. In step 1608 the analytics engine 15008 reads one or more historical values HV1-HVN maintained for the first cloud asset 1502 related to the first cloud asset 1502. In step 1610 the analytics engine 15008 reads one or more arbitrary values AV1-AVN maintained for the first cloud asset 1502 related to the first cloud asset 1502. And in step 1612 the analytics engine selects a first asset formula F1 from the cloud server memory 1500D and newly generates an updated confidence value CV for the first cloud asset 1502 and stores the updated confidence value CV in the cloud server memory 1500C in step 1614. The cloud server 1500 then updates the visual rendering of the updated confidence value CV of the dashboard 1500C in step 1616, and in step 1618 determines whether to (a.) again apply steps 1602 through 1616, generating an updated confidence value CV of the first asset 1502 or another cloud asset 1504-1512; or (b.) proceed on to step 1620 to alternate computational operations.

An example calculation of the updated confidence value CV for the first cloud asset 1502 by application of the first asset confidence value formula F1 is as follows:

CI=(HV1+AV1+A1(CM1)+A2(CM2)+B1(ECM1)+B2(ECM2))/DV

Wherein A1, A2, B1, and B2 are coefficients and a denominator measurement is a maximum possible measurement of the summed numerator of the equation. It is understood that various alternate preferred embodiments of the method of the present invention apply other suitable formula (s) known in the art or made obvious by the present disclosure to calculate confidence values CV.

For example, an alternate method of calculated confidence values might include one or more aspect of the following alternate calculations:

CS_{CO=Performance}=max(P(ca)IM(ca),CS_{CO-past-Performance}) Step 1.

CS_{Metric=Health}=max(max_{performance,realiability,more}(SᵢCS_{CCO}),CS_{Metric=Health-past}) Step 2.

CS_{Overall}=max(max_{all metrics}(SᵢCS_{Metric=Health}),CS_{Overall-past}) Step 3.
CO=Confidence Objective
ca=confidence alert
P(ca)=probability of a confidence alert
IM(ca)=impact matrix of this confidence alert
CS=confidence score
S is a scaling factor that can be chosen internally to decide the relative impact on the overall Confidence. 0<S<=1.

Referring now to FIG. 17, FIG. 17 is an illustration of a first cloud asset data record 1700 that is maintained in the cloud server memory 1500D and acts as a record of the first asset confidence value formula F1 coefficients A1-AN & B1-BN, confidence measurements CM1-CMN & ECM1-ECMN, historical measurements H1-HN, arbitrary measurements AV1-AVN previously generated confidence values CV1-CVN for the first asset 1502, and other historical data H.DATA. It is understood that the cloud server memory 1500D maintains additional cloud asset data records 1702-1714 corresponding to and applicable in relation to the additional cloud assets 1502-1512 and cloud service providers 1514 & 1516.

While the preferred embodiments have been described herein, those skilled in the art will recognize that certain details may be changed without departing from the spirit and scope of the invention. Thus, the foregoing specific embodiments and applications are illustrative only and are not intended to limit the scope of the invention.

What is claimed is:

1. A method comprising:
a. Acquiring at least two performance measurements or indicators of a remotely located computational asset;
b. Applying an algorithm to determine a probability of failure of the computational asset;
c. Visually presenting a resultant value of the algorithm to a human evaluator; and
d. Receiving a command related to modifying a current tasking of the computational asset.

2. The method of claim 1, wherein a failure state is defined to include a degradation of service quality.

3. The method of claim 1, wherein at least one performance measurement is automatically updated at least once every minute.

4. The method of claim 1, wherein at least one performance measurement is generated by a sensing software at least partly executed by the computational asset.

5. The method of claim 4, wherein the sensing software is provided to the computational asset by a party contracting for a computational service enabled by the computational asset.

6. The method of claim 1, wherein the algorithm further comprises at least one value provided by a long-term evaluation of the computational asset.

7. The method of claim 1, wherein the algorithm further comprises at least one value provided by a long-term evaluation of the operator of the computational asset.

8. The method of claim 1, wherein at least one performance measurement is processed by the algorithm within one second of transmission from the sensing software.

9. The method of claim 1, wherein the resultant value is automatically recalculated each time an updated measurement value is received.

10. The method of claim 1, wherein the resultant is rendered with a color indicator of risk probability.

11. The method of claim 1, wherein the resultant is rendered with a color indicator of confidence.

12. The method of claim 1, wherein a user interface enables the user to investigate an individual performance measurements of the computational asset.

13. The method of claim 1, wherein at least one mitigation process is made available to the user.

14. The method of claim 1, wherein at least one mitigation process is recommended to the user at least partly on the basis of the resultant value.

15. The method of claim 1, wherein a plurality of performance measurements of a plurality of computational assets are received and the algorithm is applied to each plurality of performance parameters to generate a plurality of values.

16. The method of claim 15, wherein the plurality of resultant values are individually rendered with a color indicator of risk probability.

17. The method of claim 15, wherein the plurality of resultant values are individually rendered with a color indicator of risk severity.

18. The method of claim 15, wherein a user interface enables the user to investigate an individual performance measurements of the computational asset.

19. A human-computer graphical user interface, comprising:
a. Means to acquire at least two performance measurements of a remotely located computational asset;
b. Means to apply an algorithm to determine a probability of failure of the computational asset;
c. Means to visually present a resultant value of the algorithm to a human evaluator; and
d. Means to receive and transmit a user command related to modifying a current tasking of the computational asset.

20. A system comprising:
a. Means to acquire at least two performance measurements of a remotely located computational asset;
b. Means to apply an algorithm to determine a probability of failure of the computational asset;
c. Means to visually present a resultant value of the algorithm to a human evaluator; and
d. Means to receive and transmit a user command related to modifying a current tasking of the computational asset.
